(19) United States
(12) Patent Application Publication
(10) Pub. No.: US 2017/0283711 A1
(43) Pub. Date: Oct. 5, 2017

(54) METHODS FOR FRACTIONATION OF LUBRICANT FEEDS

(71) Applicant: ExxonMobil Research and Engineering Company, Annandale, NJ (US)

(72) Inventors: Fengrong Chen, Spring, TX (US); Zalina Abd Rahman, The Woodlands, TX (US)

(21) Appl. No.: 15/453,272

(22) Filed: Mar. 8, 2017

Related U.S. Application Data
(60) Provisional application No. 62/315,795, filed on Mar. 31, 2016.

(51) Int. Cl. C10G 7/06; B01D 3/32; B01D 3/10; C10M 101/02; C10M 105/00

(52) U.S. Cl. CPC C10G 7/06; C10M 101/02; C10M 105/00; B01D 3/10; B01D 3/32; C10G 2300/302; C10G 2300/301; C10G 2400/10; C10M 2203/003; C10M 2203/1006; C10N 2220/022

(57) ABSTRACT

Systems and methods are provided for the fractionation of lubricant feeds. A lubricant feed can be introduced into a vacuum distillation tower having a reduced pressure and a reduced or minimized water vapor partial pressure. The lubricant feed can be separated into a plurality of lubricant boiling range products. The can allow an overlap in boiling ranges of one or more products separated from the lubricant feed to be reduced or minimized.

### CROSS-REFERENCE TO RELATED APPLICATIONS

This application claims priority to U.S. Provisional Application No. 62/315,795 filed Mar. 31, 2016, which is herein incorporated by reference in its entirety.

### FIELD

Systems and methods are provided for the fractionation of lubricant boiling range feeds.

### BACKGROUND

Vacuum fractionation systems for lubricant boiling range feeds can include injecting substantial amounts of steam into a vacuum furnace, a distillation tower, and in any strippers. While this system can produce various fractionated lubricant products, these products may contain a significant amount of water. Therefore, these systems also typically include a dryer to remove this water from the fractionated products.

### SUMMARY

In some aspects, a method for the fractionation of a lubricant boiling range feed is provided. The method can include introducing a lubricant boiling range feed into a flash zone of a distillation tower. The lubricant boiling range feed can optionally include light ends, naphtha, and/or diesel, so that the T10 and/or T20 and/or T30 boiling point of the lubricant boiling range feed is at least 343° C. The distillation tower can have a pressure of 3.5 kPa or less, a water vapor partial pressure of 0.5 kPa or less, or a combination thereof. The lubricant boiling range feed can be separated into at least a first lubricant boiling range product and a second lubricant boiling range product. The first lubricant boiling range product can have a T95 boiling point that is greater than a T5 boiling point of the second lubricant boiling range product by 14° C. or less (or 11° C. or less, or 8° C. or less, or 6° C. or less). The T95 boiling point of the second lubricant boiling range product can be greater than the T95 boiling point of the first lubricant boiling range product. Optionally but preferably, the distillation tower can have a pressure of 2.0 kPa or less, or 1.5 kPa or less. Optionally, the water vapor partial pressure can correspond to a water vapor partial pressure based on introducing substantially no additional water into the distillation tower.

Optionally, the first lubricant boiling range product can have a kinematic viscosity at 100° C. of 2 to 4 cSt and the second lubricant boiling range product has a kinematic viscosity at 100° C. of 4 to 10 cSt. Optionally, the first lubricant boiling range product can have a kinematic viscosity at 100° C. of 4 to 10 cSt and the second lubricant boiling range product has a kinematic viscosity at 100° C. of 10 to 16 cSt. Optionally, both the first and second lubricant boiling range products can have a kinematic viscosity at 100° C. of 4 to 10 cSt, with the first lubricant boiling range product having a kinematic viscosity at 100° C. that is less than the kinematic viscosity at 100° C. of the second lubricant boiling range product.

In other aspects, a system for the fractionation of a lubricant boiling range feed is provided. The system can include a distillation tower having a pressure of 3.5 kPa or less and/or a water vapor partial pressure of 0.5 kPa or less. The distillation tower can further have a lubricant boiling range feed therein, the lubricant boiling range feed having a viscosity index (VI) of at least 50, such as at least about 70. The system can further include at least one stripper in fluid communication with the distillation tower. The system can further include at least one reboiler loop in fluid communication with the stripper. Optionally, the distillation tower can include a plurality of fractionation outlets for removing fractions from the distillation tower. The stripper can optionally include a liquid fraction withdrawn from the distillation tower and a stripper medium including a vaporized portion of the fraction heated in the reboiler loop. Optionally but preferably, the distillation tower can have a pressure of 2.0 kPa or less, or 1.5 kPa or less. Optionally, the water vapor partial pressure can correspond to a water vapor partial pressure based on introducing substantially no additional water into the distillation tower.

In still other aspects, a plurality of lubricant boiling range products are provided. The plurality of lubricant boiling range products can include first and second lubricant boiling range products formed by the fractionation of a hydroprocessed and/or solvent processed lubricant boiling range feed in a distillation tower. The first lubricant boiling range product can have a T95 boiling point that is greater than a T5 boiling point of the second lubricant boiling range product by 14° C. or less. A T95 boiling point of the second lubricant boiling range product can be greater than the T95 boiling point of the first lubricant boiling range product.

### BRIEF DESCRIPTION OF THE FIGURES

FIG. 1 schematically shows an example of a system for fractionating lubricant boiling range feeds, according to an aspect of the disclosure.

### DETAILED DESCRIPTION

### Overview

All numerical values within the detailed description and the claims herein are modified by “about” or “approximately” the indicated value, and take into account experimental error and variations that would be expected by a person having ordinary skill in the art.

In various aspects, systems and methods are provided for the fractionation of lubricant boiling range feeds. In one or more aspects, a lubricant boiling range feed can be introduced into a flash zone of a vacuum distillation tower. The vacuum distillation tower can be operated at a total pressure of 3.5 kPa-a (0.51 psia) or less, or 3.0 kPa-a or less, or 2.5 kPa-a or less, or 2.0 kPa-a or less, or 1.5 kPa-a or less, or 1.0 kPa-a or less, and a water vapor partial pressure of 0.5 kPa-a (0.07 psia) or less, or 0.1 kPa-a or less, or 0.05 kPa-a or less. In some optional aspects, the water vapor partial pressure can correspond to a partial pressure that is achieved based only on the inherent water content of the lubricant boiling range feed and/or the inherent water content of any other (non-aqueous) process fluids introduced into the system. In other words, the water vapor partial pressure can correspond to the water vapor partial pressure that is present when substantially no additional water is introduced into the vacuum distillation tower. In such aspects, the lubricant boiling range feed can be fractionated into a plurality of lubricant boiling range products having reduced or minimized overlap in boiling range between adjacent fractions produced during fractionation.

Traditional vacuum fractionation of lubricant boiling range feeds can include exposing the feed to steam and moderate sub-atmospheric pressures, e.g., 14.0 kPa-a (2.0 psia) or greater. The steam can be used to assist with heating the feed and/or to assist with volatilizing the lower boiling portions of the feed. In a traditional fractionation system, substantial quantities of steam may be injected into the vacuum furnace and any strippers, which can make it difficult to produce a low enough vacuum in order to maximize the separation of the various fractions. Further, due to the significant amounts of steam utilized throughout traditional systems, energy intensive dryers are typically required in order to reduce or minimize the water content from the fractionated lubricant base stock products.

In some aspects, the systems and processes described herein can address one or more of the above problems. In certain aspects, the fractionation system disclosed herein includes a distillation tower that is operated with little or no steam, e.g., water vapor partial pressure of 0.5 kPa-a (0.07 psia) or less, or 0.1 kPa-a or less, or 0.05 kPa-a or less. In such aspects, because there is little to no steam in the tower, the tower can be operated at a reduced pressure, e.g., 3.5 kPa-a (0.51 psia) or less, or 2.0 kPa-a or less, compared to the traditional systems. In various aspects, this combination of reduced pressure and little to no steam in the tower can allow for a reduced or minimized overlap in boiling range between adjacent fractions produced during fractionation, such as a light lubricant base stock fraction and a medium lubricant base stock fraction. For example, the improved separation between adjacent fractions can reduce the distillation overlaps between one or more of the adjacent fractions to 25° F. (14° C.) or less, or 20° F. (11° C.) or less, or 15° F. (8° C.) or less, or 11° F. (6° C.) or less. Optionally, all of the lubricant boiling range fractions produced during distillation can have a distillation overlap with adjacent lubricant boiling range fraction(s) of 25° F. (14° C.) or less, or 20° F. (11° C.) or less, or 15° F. (8° C.) or less, or 11° F. (6° C.) or less.

In addition to reducing or minimizing the overlap between adjacent fractions, utilizing a vacuum fractionation system with a reduced or minimized amount of steam can have a number of other benefits, many of which result in reduced operating costs. For example, such a system can reduce the requirement for vacuum dryer ejectors, can reduce the amount of condensed water in the overhead circuit, and/or can reduce the amount of fuel gas required for the furnace, since the feed is not heated to the higher temperatures utilized in a traditional fractionation system. Further, due to the reduced amount of steam (or no steam) and/or the reduced pressure, the tower bottom temperature and/or the furnace temperature can be more easily controlled to less than 650° F. (343° C.) to minimize the impact of thermal cracking on product quality and yield.

In this discussion, unless otherwise specified, “lubricant boiling range” refers to an initial or T5 boiling point of at least 650° F. (343° C.), and a final or T95 boiling point of 1050° F. (566° C.). In this discussion, unless otherwise specified, “lubricant boiling range compounds” or “lubricant boiling range products” refers to one or more compounds, products, streams, and/or fractions that exhibit the lubricant boiling range specified above. In this discussion, unless otherwise specified, “diesel boiling range” refers to an initial or T5 boiling point of at least 350° F. (177° C.), and a final or T95 boiling point of less than 650° F. (343° C.). In this discussion, unless otherwise specified, “diesel boiling range compounds” refers to one or more compounds that exhibit the diesel boiling range specified above. In this discussion, unless otherwise specified, “naphtha boiling range” refers to an initial or T5 boiling point of at least 50° F. (10° C.), and a final or T95 boiling point of less than 350° F. (177° C.). In this discussion, unless otherwise specified, “naphtha boiling range compounds” refers to one or more compounds that exhibit the naphtha boiling range specified above. In this discussion, unless otherwise specified, “T5 boiling point” refers to a temperature at which 5 wt. % of the feed, effluent, product, stream, or composition of interest will boil. In this discussion, unless otherwise specified, “T95 boiling point” refers to a temperature at which 95 wt. % of the feed, effluent, product, stream, or composition of interest will boil. In this discussion, unless otherwise specified, a “heavier fraction, product, component, or cut” refers to a fraction, product, component, or cut that has a higher boiling point relative to the boiling point of another fraction, product, component, or cut. In this discussion, unless otherwise specified, a “lighter fraction, product, component, or cut” refers to a fraction, product, component, or cut that has a lower boiling point relative to the boiling point of another fraction, product, component, or cut.

### Lubricant Boiling Range Feed

The lubricant boiling range feed can be any mineral or bio-derived hydrocarbon or hydrocarbon-like feed having one or more lubricant boiling range compounds. In certain aspects, the feed can include a solvent processed and/or hydroprocessed lubricant boiling range fraction. In various aspects, the lubricant boiling range feed can have a viscosity index (VI) of at least 50, at least 70, or at least 80.

In some aspects, the lubricant boiling range feed has a T5 boiling point of at least 650° F. (343° C.), or at least 700° F. (371° C.), and/or a final or T95 boiling point of 1150° F. (621° C.) or less, or 1100° F. (593° C.) or less, or 1050° F. (566° C.) or less, or 1000° F. (538° C.) or less. Alternatively, due to prior hydroprocessing, a lubricant boiling range feed for distillation may include some lower boiling fractions, such as light ends and/or naphtha and/or diesel. In such aspects, a feed may have a T10 boiling point of at least 343° C., or a T20 boiling point of at least 343° C., or a T30 boiling point of at least 343° C. In such aspects, the properties of a lubricant boiling range feed as described herein can refer to the 650° F.+(343° C.) portion of the feed. In the same or alternative aspects, the lubricant boiling range feed can have a density at 60° F. (15.6° C.) of at least 0.83 g/cm³, or at least 0.84 g/cm³, or at least 0.85 g/cm³, and/or less than 0.93 g/cm³, or less than 0.92 g/cm³, or less than 0.91 g/cm³, or less than 0.90 g/cm³.

In one or more aspects, sulfur can be present in the lubricant boiling range feed. In such aspects, the lubricant boiling range feed can have a sulfur content of at least 1 wppm, 5 wppm, at least 10 wppm, or at least 20 wppm. In the same or alternative aspects, the lubricant boiling range feed can have a sulfur content of 300 wppm or less, 250 wppm or less, 200 wppm or less, 100 wppm or less, 50 wppm or less, or 25 wppm or less. In various aspects, the sulfur may be present as organically bound sulfur.

In certain aspects, the lubricant boiling range feed may include water vapor or process steam in an amount of 1 vol. % or less, 0.1 vol. % or less, or 0.01 vol. % or less.

In one or more aspects, the lubricant boiling range feed can include one or more fractions suitable for use as a Group I basestock, Group II basestock, or Group III basestock. Group I basestocks or base oils are defined as base oils with less than 90 wt % saturated molecules and/or at least 0.03 wt % sulfur content. Group I basestocks also have a VI of at least 80 but less than 120. Group II basestocks or base oils contain at least 90 wt % saturated molecules and less than 0.03 wt % sulfur. Group II basestocks also have a viscosity index of at least 80 but less than 120. Group III basestocks or base oils contain at least 90 wt % saturated molecules and less than 0.03 wt % sulfur, with a viscosity index of at least 120. In addition to the above formal definitions, some Group I basestocks may be referred to as a Group I+ basestock, which corresponds to a Group I basestock with a VI value of 103 to 108. Some Group II basestocks may be referred to as a Group II+ basestock, which corresponds to a Group II basestock with a VI of at least 113. Some Group III basestocks may be referred to as a Group III+ basestock, which corresponds to a Group III basestock with a VI value of at least 140.

### Fractionation of the Lubricant Boiling Range Feed: Vacuum Distillation Tower

As discussed above, in various aspects, the lubricant boiling range feed can be subjected to vacuum distillation in the presence of a reduced or minimized partial pressure of water. For example, in certain aspects, the lubricant boiling range feed can be subjected to vacuum distillation in order to separate the feed into a plurality of lubricant boiling range products.

In certain aspects, the feed can be subjected to vacuum distillation in a vacuum distillation tower. In various aspects, the vacuum distillation tower can include alternating zones or series of packings or other internal structures for fractionation of the feed. The locations of the packings or other internal structures and/or their spacing can be positioned to optimize recovery of various fractions of the feed. In certain aspects, other internal structures can include random packings, structured packings grids, liquid or vapor distributors, and/or liquid and vapor collectors. The vacuum distillation tower can also include other typical fractionator parts and/or features, such as a flash zone. Further, the vacuum distillation tower can include a plurality of fractionation outlets for removing a portion of the feed. In addition, the vacuum distillation tower can be in fluid communication with various strippers and reboilers as discussed below.

In one or more aspects, the feed may be heated prior to entering the vacuum distillation tower. For example, the lubricant boiling range feed can be heated to a temperature of at least 482° F. (250° C.), at least 527° F. (275° C.), or at least 572° F. (300° C.). In the same or alternative aspects, the lubricant boiling range feed can be heated to a temperature of 752° F. (400° C.) or less, 716° F. (380° C.) or less, or 680° F. (360° C.) or less. In certain aspects, the lubricant boiling range feed can be heated to a temperature of 482° F. (250° C.) to 752° F. (400° C.); a temperature of 482° F. (250° C.) to 716° F. (380° C.); a temperature of 482° F. (250° C.) to 680° F. (360° C.); a temperature of 527° F. (275° C.) to 752° F. (400° C.); a temperature of 527° F. (275° C.) to 716° F. (380° C.); a temperature of 527° F. (275° C.) to 680° F. (360° C.); a temperature of 572° F. (300° C.) to 752° F. (400° C.); a temperature of 572° F. (300° C.) to 716° F. (380° C.); or a temperature of 572° F. (300° C.) to 680° F. (360° C.). In one or more aspects, the lubricant boiling range feed can be heated in a conventional refinery furnace at atmospheric pressure. In certain aspects, such a furnace can be in fluid communication with the vacuum distillation tower, e.g., at the flash zone of the tower.

In one or more aspects, the lubricant boiling range feed can be introduced into a flash zone of the vacuum distillation tower, where the feed is exposed to reduced pressure. In such aspects, the distillation tower can have a pressure of 3.5 kPa-a (0.51 psia) or less, or 3.0 kPa-a or less, or 2.5 kPa-a or less, or 2.0 kPa-a or less, or 1.5 kPa-a or less, or 1.0 kPa-a or less. For example, the distillation tower can have a pressure of 0.1 kPa-a to 3.5 kPa-a, or 0.1 kPa-a to 3.0 kPa-a, or 0.1 kPa-a to 2.5 kPa-a, or 0.1 kPa-a to 2.0 kPa-a, or 0.1 kPa-a to 1.5 kPa-a, or 0.1 kPa-a to 1.0 kPa-a, 0.5 kPa-a to 3.5 kPa-a, or 0.5 kPa-a to 3.0 kPa-a, or 0.5 kPa-a to 2.5 kPa-a, or 0.5 kPa-a to 2.0 kPa-a, or 0.5 kPa-a to 1.5 kPa-a.

As mentioned above, in one or more aspects, the vacuum distillation tower can be run at the lower pressures, such as the pressures described above, because little to no steam is present in the distillation tower. In certain aspects, the partial pressure of water vapor or process steam in the vacuum distillation tower can be 0.5 kPa-a (0.07 psia) or less, or 0.1 kPa-a or less, or 0.05 kPa-a or less. In the same or alternative aspects, the vacuum distillation tower may include water vapor or process steam in an amount of 1 vol. % or less, 0.1 vol. % or less, or 0.01 vol. % or less.

In various aspects, in the vacuum distillation tower, the lubricant boiling range feed can be fractionated into, at least, a plurality of lubricant boiling range products. In such aspects, the vacuum distillation tower can be operated by one skilled in the art to control the cut points for obtaining the desired fractions withdrawn from the tower.

Below, various fractions are described and discussed with regard to further processing in the fractionation. It should be appreciated that the fractions discussed below are only exemplary and any number of fractions can be obtained.

### Fractionation of the Lubricant Boiling Range Feed: Liquid Bottoms Fraction

Once the lubricant boiling range feed enters the flash zone of the vacuum distillation tower, a portion of the heated lubricant boiling range feed may not vaporize and can be eluted from the tower as liquid bottoms. In such aspects, at least a portion of this liquid bottoms may be withdrawn from the vacuum distillation tower. In certain aspects this bottom fraction can have a temperature of 650° F. (343° C.) or less, or 640° F. (338° C.) or less, or 630° F. (332° C.) or less, or 620° F. (327° C.) or less.

In one or more aspects, since the vacuum distillation tower can be operated with no steam (or a little amount) the bottoms fraction does not need to be dried with a drying unit, as may be the case with a fractionation system that utilizes steam. In certain aspects, at least a portion of the bottoms may be passed into a heater in a reboiler loop, in order to remove and/or vaporize at least a portion of the light products therein and return them to the vacuum distillation tower. The reboiler loop can be any conventional reboiler loop used in oil refineries. In certain aspects, the reboiler loop can be in fluid communication with the vacuum distillation tower, e.g., such that the vaporized products can be returned to a position in the tower that is approximately close to the bottom of a set of packings or other internal structures used for condensation of the vaporized feed.

In various aspects, the resulting liquid bottoms fraction can include a heavy lubricant base stock product. In one or more aspects, the resulting liquid bottoms fraction may be utilized as a base stock product for forming finished lubricant products. In certain aspects such a base stock product may be a heavy lubricant base stock product having a kinematic viscosity at 100° C. of 10 cSt to 16 cSt. More generally, a base stock corresponding to a bottoms fraction from a distillation can have any convenient kinematic viscosity at 100° C. from 4 cSt to 32 cSt or more, with the bottoms fraction typically having a greater kinematic viscosity at 100° C. than the adjacent lubricant boiling range fraction (or other fraction) produced by the vacuum distillation.

### Fractionation of the Lubricant Boiling Range Feed: Lubricant Base Stock Fractions

As the heated lubricant boiling range feed enters the flash zone of the vacuum distillation tower, at least a portion of the feed may be vaporized and travel up through the tower where a portion may condense on a set of packings or other internal structures. In various aspects, a fraction, e.g., a stream lighter than the bottoms, can be withdrawn from the vacuum distillation tower at one or more fractionation outlets in the tower based on the desired end product or fraction. In certain aspects, this fraction can be withdrawn from a position near or below a set of packings or other internal structures used for condensation of the vaporized feed. In such aspects, the withdrawn fraction may be subjected to a stripper in order to return any lighter or lower boiling point products to the vacuum distillation tower.

In certain aspects, the stripper can be any conventional stripper used in a fractionation system found at an oil refinery. In one or more aspects, the stripper can include a vessel having a single set of packings or other internal structures for separating a lighter portion of the effluent stream to return to the vacuum distillation tower. In such aspects, the withdrawn fraction may enter the stripper at a position near the top of, or above, the set of packings or other internal structures positioned in the stripper.

In certain aspects, the withdrawn liquid fraction that enters the stripper can flow down through the set of packings or other internal structures and may be exposed to a stripper medium moving up the stripper, such as a heated vapor stream. This stripper medium may heat the withdrawn liquid fraction, which may cause some lighter portion of the withdrawn liquid fraction to vaporize and exit the top of the stripper, which is in fluid communication with the distillation tower, thereby allowing this vaporized portion to return to the vacuum distillation tower. In one or more aspects, 5% to 20% of the withdrawn liquid fraction that entered the stripper may become vaporized and return to the vacuum distillation tower.

In certain aspects, the stripper medium flowing through the stripper can be generated by heating (e.g., via a reboiler loop in fluid communication with the stripper) a portion of the withdrawn liquid fraction exiting the bottom of the stripper to form a heated vapor stream. In one or more aspects, this heated vapor stream may enter the bottom of the stripper just below the set of packings or other internal structures therein. This configuration can save significant amount of energy and resources as it replaces the steam as the stripping gas with a heated vapor stream of the tower effluent. Further, since steam is not mixed with the tower effluent, this configuration does not require the use of vacuum dryer or other dryer for the product exiting the bottom of the stripper.

In one or more aspects, the withdrawn liquid fraction that exits the bottom of the stripper may be utilized as a base stock product for forming finished lubricant products.

In various aspects, any convenient number of lubricant base stock fractions can be withdrawn from a fractionator in order to produce a desired slate of base stock products. Examples of potential fractions can include, but are not limited to, one or more bright stock products having a kinematic viscosity at 100° C. of 16 cSt to 32 cSt or more, one or more heavy lubricant base stock products having a kinematic viscosity at 100° C. of 10 cSt to 16 cSt, one or more medium lubricant base stock products having a kinematic viscosity at 100° C. of 4 cSt to 10 cSt, and/or one or more light lubricant base stock products having a kinematic viscosity at 100° C. of 2 cSt to 4 cSt. In various aspects, the vacuum distillation tower may be configured to provide a withdrawn liquid fraction resulting in a medium lubricant base stock product and another withdrawn liquid fraction further up the tower resulting in a light lube base stock product. In certain aspects, such a medium lubricant base stock product can be an adjacent lighter (or lower boiling point) fraction to the liquid bottoms fraction. Further, in certain aspects, a medium lubricant base stock product can be an adjacent heavier (or higher boiling point) fraction to a light lubricant base stock product.

In various aspects, one or more adjacent fractions (i.e., a higher boiling point fraction and a lower boiling point fraction) from the vacuum distillation tower can have a distillation overlap of 25° F. (14° C.) or less, 20° F. (11° C.) or less, 15° F. (8° C.) or less, or 11° F. (6° C.) or less. For example, in one aspect, the T95 boiling point of a light lubricant base stock product could be greater than the T5 boiling point of a medium lubricant base stock product by 25° F. (14° C.) or less, or 20° F. (11° C.) or less, or 15° F. (8° C.) or less, or 11° F. (6° C.) or less. In another exemplary aspect, the T95 boiling point of a medium lubricant base stock product can be greater than the T5 boiling point of a heavy lubricant base stock product by 25° F. (14° C.) or less, or 20° F. (11° C.) or less, or 15° F. (8° C.) or less, or 11° F. (6° C.) or less. Further in another exemplary aspect, the T95 boiling point of a diesel boiling range fraction can be than the T5 boiling point of a light lubricant base stock product by 25° F. (14° C.) or less, or 20° F. (11° C.) or less, or 15° F. (8° C.) or less, or 11° F. (6° C.) or less.

In certain aspects, the T95 boiling point of a heavier or higher boiling point fraction is greater than the T95 boiling point of an adjacent lighter or lower boiling point fraction. For example, in one aspect, the T95 boiling point of a medium lubricant base stock product can be greater than the T95 boiling point of a light lubricant base stock product. In another exemplary aspect, the T95 boiling point of a heavy lubricant base stock product can be greater than the T95 boiling point of a medium lubricant base stock product. Further in another exemplary aspect, the T95 boiling point of a light lubricant base stock product can be greater than the T95 boiling point of a diesel boiling range fraction.

### Fractionation of the Lubricant Boiling Range Feed: Non-Lubricant Fractions

In various aspects, depending on the constituents in the lubricant boiling range feed, the vacuum distillation tower may also have one or more effluent streams for the lighter or lower boiling point products that may not result in lubricant base stock products. For example, an effluent stream having a portion of diesel boiling range compounds (and/or lighter or lower boiling point compounds) may be removed from the tower. In various aspect, a portion of this effluent stream may be removed and sent to a cooler in order to condense the heavier, higher boiling range components and return such components to the tower. In such aspects, the heavier components may be returned to the vacuum distillation tower at a position above the series of sets of packings or other internal structures in the tower. The cooler can be any conventional cooler utilized in fractionation or other systems at oil refineries. In certain aspects, a fraction having diesel boiling range compounds can be a lower boiling point adjacent fraction to a fraction resulting in a light lubricant base stock product.

In addition, a portion of the vaporized lubricant boiling range feed may not condense on any of the packings or other internal structures in the tower and may exit the tower as an overhead stream, as discussed further below. In addition, a vaporized fraction from the tower that did not condense on any of the sets of packings or internal structures can exit the top of the tower as an overhead fraction and sent to ejectors. In such aspects, this overhead fraction may include one or more of naphtha boiling range compounds and light ends.

### Example of Vacuum Fractionation System Configuration

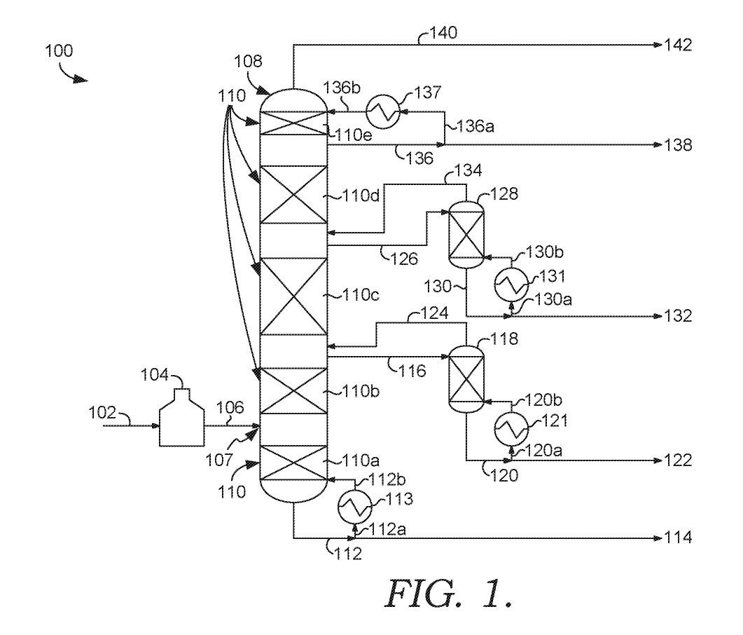

FIG. 1 depicts one example of a fractionation system 100 for fractionating a lubricant boiling range feed. Initially, a lubricant boiling range feed 102 can be heated in a furnace 104, such as within the temperature range discussed above. In such aspects, the heated lubricant boiling range feed 106 enters the flash zone 107 of a vacuum fractionation tower 108. The vacuum fractionation tower 108 can include one or more of the properties and parameters discussed above. For example, in one aspect, the tower 108 can include a series 110 of packings or other internal structures (e.g., packing sets 110a, 110b, 110c, 110d, and 110e).

In various aspects, once the heated lubricant boiling range feed 106 enters the reduced pressure environment of the tower 108, a portion of the heated lubricant boiling range feed 106 may vaporize and travel up the tower 108. In certain aspects, a portion of the heated lubricant boiling range feed 106 does not vaporize and ends up as a liquid bottom fraction 112 that exits the bottom of the tower 108. In such aspects, a portion 112a of the liquid bottom fraction 112 can be exposed to a reboiler 113, in order to vaporize and return a lighter vaporized portion 112b back to the tower 108. In certain aspects, the resulting liquid bottom fraction 112 can be a heavy lubricant base stock product 114.

In various aspects, the vaporized portion of the heated lubricant boiling range feed 106 travels up the tower 108 and may condense, for example, on the packing set 110c and exit the tower 108 as an effluent stream 116. In such aspects, the effluent stream 116 may be exposed to a stripper 118, which includes a rising countercurrent heated vapor. In certain aspects, this rising countercurrent heated vapor can be formed from a portion 120a of the liquid stream 120 that exits the bottom of the stripper 118. This portion 120a can vaporize, e.g., via the reboiler 121, forming a vaporized portion 120b that is returned to the bottom of the stripper 118. In one or more aspects, the vaporized portion 120b that does not condense in the stripper 118 (along with any vaporized portion from the liquid stream 120 inside the stripper) will be returned to the tower as a vapor return stream 124. In certain aspects, the resulting liquid steam 120 exiting the stripper 118 can be a medium lubricant base stock product 122.

In certain aspects, a vaporized portion of the heated lubricant boiling range feed 106 travels up the tower 108 and may condense, for example, on the packing set 110d and exit the tower 108 as an effluent stream 126. In such aspects, the effluent stream 126 may be treated similarly to the effluent stream 116 discussed above. For example, the effluent stream 126 can be exposed to a stripper medium in a stripper 128, which can include a rising countercurrent heated vapor. In certain aspects, this rising countercurrent heated vapor can be formed from a portion 130a of the liquid stream 130 that exits the bottom of the stripper 128. This portion 130a can vaporize, e.g., via a reboiler 131, forming a vaporized portion 130b that is returned to the bottom of the stripper 128. In one or more aspects, the vaporized portion 130b that does not condense in the stripper 128 (along with any vaporized portion from the liquid stream 130 inside the stripper) will be returned to the tower as a vapor return stream 134. In certain aspects, the resulting liquid steam 130 exiting the stripper 128 can be a medium lubricant base stock product 132.

Another portion of the vaporized heated lubricant boiling range feed 106 may condense, for example, on tray set 110e and exit the tower as an effluent stream 136. In such aspects, a portion 136a of the effluent stream 136 may be subjected to a cooler 137 to form a condensed portion 136b that is sent back to the tower 108 for further fractionation. In certain aspects, the resulting effluent 136 can be a diesel boiling range fraction 138.

In certain aspects, a portion of the vaporized lubricant boiling range feed that does not condense on any structures within the tower 108 can exit the tower 108 as an overhead fraction 140 that is sent to the system ejectors 142.

In certain aspects, adjacent products: 114 and 122; 122 and 132; and 132 and 138, can have similar boiling range overlaps as those discussed above.

### EXAMPLE

### Comparison of Fractionation Systems

It has been discovered that exposing a lubricant boiling range feed to a fractionation system including a vacuum distillation tower having a reduced pressure with a reduced or minimized amount of added steam (possibly corresponding to no added steam) can provide enhanced separation between each lighter and adjacent heavier fraction compared to a fractionation system including a distillation tower that utilizes increased (i.e., conventional) amounts of water vapor.

Table 1 below shows modeling data of simulated fractionation systems performed on empirical models using a commercially available chemical engineering program. Fractionation system 1 refers to a conventional system including a vacuum distillation tower that utilizes steam to assist the fractionation. Fractionation system 2 refers to a system including a vacuum distillation tower having a pressure of 2.0 kPa-a (0.29 psia) or less, with substantially no additional steam added to the tower. Fractionation system 2 can include a similar configuration to the system 100 depicted in FIG. 1.

TABLE 1
Modeling Data

| | Fractions | System 1 | System 2 |
|---|---|---|---|
| Distillation Overlaps | Diesel (T95) − Light | 30.1° F. | 10.2° F. |
| (T95 boiling point- | lubricant base stock | (16.7° C.) | (6° C.) |
| T5 boiling point) | product (T5) | | |
| (° F. (° C.)) | Light lubricant base | 39.1° F. | 11.2° F. |
| | stock product (T95) − | (21.7° C.) | (6.2° C.) |
| | Medium lubricant | | |
| | base stock product | | |
| | (T5) | | |
| | Medium lubricant | 83.6° F. | 10.2° F. |
| | base stock product | (46.5° C.) | (6° C.) |
| | (T95) − Heavy | | |
| | lubricant base stock | | |
| | product (T5) | | |
| Duty | Heating (furnace + | 58 | 58.5 |
| (MMBTU/hr) | reboilers) | | |
| | Cooling (TPA) | −49 | −61.2 |

As can be seen in Table 1, the overlap in boiling ranges for adjacent fractions is significantly higher for the fractionation system using increased levels of steam and pressure (system 1) compared to the fractionation system 2 having reduced pressure and significantly reduced (or no) steam. For example, in system 1 the T95 boiling point for the diesel fraction is 30.1° F. (16.7° C.) greater than then the T5 boiling point for the light lubricant base stock product. Further, as the adjacent cuts get heavier, the overlap in boiling ranges for adjacent cuts in system 1 with the increased pressure and steam levels only get higher: the T95 boiling point of the light lubricant base stock product is 39.1° F. (21.7° C.) greater than the T5 boiling point of the medium lubricant base stock product; and the T95 boiling point of the heavy lubricant base stock product is 83.6° F. (46.5° C.) greater than the T5 boiling point of the medium lubricant base stock product.

By contrast, the fractionation system corresponding to system 2, having reduced levels of pressure and substantially no added water vapor, has relatively consistent overlap in boiling ranges that is also significantly reduced compared to the results for system 1. For example, the T95 boiling point of each lighter cut is only ˜6° C. greater than the T5 boiling point of an adjacent heavier cut.

This simulated data appear to show that the fractionation system (system 2) using little to no steam and a reduced pressure can provide consistently improved separation between each lighter and adjacent heavier cut.

### Additional Embodiments

Embodiment 1. A method for the fractionation of a lubricant boiling range feed, comprising: introducing a lubricant boiling range feed into a flash zone of a distillation tower, the distillation tower having a pressure of 3.5 kPa-a or less (or 3.0 kPa-a or less, or 2.5 kPa-a or less, preferably 2.0 kPa-a or less, or 1.5 kPa-a or less, or 1.0 kPa-a or less), and a water vapor partial pressure of 0.5 kPa-a or less (or 0.1 kPa-a or less, or 0.05 kPa-a or less); and separating the lubricant boiling range feed into at least a first lubricant boiling range product and a second lubricant boiling range product, wherein the first lubricant boiling range product has a T95 boiling point that is greater than a T5 boiling point of the second lubricant boiling range product by 14° C. or less (or to 11° C. or less, or 8° C. or less, or 6° C. or less), and wherein a T95 boiling point of the second lubricant boiling range product is greater than the T95 boiling point of the first lubricant boiling range product, the water vapor partial pressure optionally corresponding to a water vapor partial pressure based on introducing substantially no additional water into the distillation tower.

Embodiment 2. The method of Embodiment 1, further comprising withdrawing a fraction of the lubricant boiling range feed from the distillation tower and passing a portion of the fraction through a reboiler loop.

Embodiment 3. The method of any of the above embodiments, further comprising withdrawing a fraction of the lubricant boiling range feed from the distillation tower and passing a portion of the fraction through a stripper, wherein optionally a stripper medium in the stripper comprises a heated vapor stream from a reboiler loop associated with the stripper, and wherein the heated vapor stream comprises a stream of vaporized components of the fraction formed in the reboiler loop.

Embodiment 4. The method of any of the above embodiments, wherein the plurality of lubricant boiling range products further comprises a liquid bottoms fraction, wherein the liquid bottoms fraction has a temperature of 650° F. (343° C.) or less, or 640° F. (338° C.) or less, or 630° F. (332° C.) or less, or 620° F. (327° C.) or less, as the liquid bottoms fraction exits the distillation tower.

Embodiment 5. The method of any of the above embodiments, wherein a) the first lubricant boiling range product has a kinematic viscosity at 100° C. of 2 to 4 cSt and the second lubricant boiling range product has a kinematic viscosity at 100° C. of 4 to 10 cSt, or b) the first lubricant boiling range product has a kinematic viscosity at 100° C. of 4 to 10 cSt and the second lubricant boiling range product has a kinematic viscosity at 100° C. of 10 to 16 cSt, or c) both the first and second lubricant boiling range products have a kinematic viscosity at 100° C. of 4 to 10 cSt, and wherein the first lubricant boiling range product has a kinematic viscosity at 100° C. that is less than the kinematic viscosity at 100° C. of the second lubricant boiling range product.

Embodiment 6. The method of any of the above embodiments, wherein separating the lubricant boiling range feed further comprises forming at least one diesel boiling range fraction, at least one naphtha boiling range fraction, or a combination thereof.

Embodiment 7. The method of any of the above embodiments, wherein an overhead fraction from the distillation tower comprises naphtha boiling range compounds or light ends.

Embodiment 8. The method of any of the above embodiments, wherein the lubricant boiling range feed is a solvent processed or hydroprocessed lubricant boiling range fraction.

Embodiment 9. The method of any of the above embodiments, further comprising heating the lubricant boiling range feed to a temperature of 752° F. (400° C.) or less prior to introducing the lubricant boiling range feed into the flash zone.

Embodiment 10. The method of any of the above embodiments, wherein the lubricant boiling range feed has a T10 boiling point of at least 343° C., or a T20 boiling point of at least 343° C., or a T30 boiling point of at least 343° C.

Embodiment 11. A system for the fractionation of a lubricant boiling range feed, comprising a distillation tower having a pressure of 3.5 kPa-a or less (or 3.0 kPa-a or less, or 2.5 kPa-a or less, preferably 2.0 kPa-a or less, or 1.5 kPa-a or less, or 1.0 kPa-a or less) and a water vapor partial pressure of 0.5 kPa-a or less (or 0.1 kPa-a or less, or 0.05 kPa-a or less), the distillation tower having a lubricant boiling range feed therein, the lubricant boiling range feed having a viscosity index (VI) of at least 50 (or at least 70); at least one stripper in fluid communication with the distillation tower; and at least one reboiler loop in fluid communication with the stripper, wherein the distillation tower comprises a plurality of fractionation outlets for removing fractions from the distillation tower, the stripper optionally including a liquid fraction withdrawn from the distillation tower and a stripper medium comprising a vaporized portion of the fraction heated in the reboiler loop, the water vapor partial pressure optionally corresponding to a water vapor partial pressure based on introducing substantially no additional water into the distillation tower.

Embodiment 12. A plurality of lubricant boiling range products, comprising: first and second lubricant boiling range products formed by the fractionation of a hydroprocessed and/or solvent processed lubricant boiling range feed in a distillation tower, wherein the first lubricant boiling range product has a T95 boiling point that is greater than a T5 boiling point of the second lubricant boiling range product by 14° C. or less (or 11° C. or less, or 8° C. or less, or 6° C. or less), and wherein a T95 boiling point of the second lubricant boiling range product is greater than the T95 boiling point of the first lubricant boiling range product.

Embodiment 13. The plurality of lubricant boiling range products of Embodiment 12, wherein a) the first lubricant boiling range product has a kinematic viscosity at 100° C. of 2 to 4 cSt and the second lubricant boiling range product has a kinematic viscosity at 100° C. of 4 to 10 cSt, orb) the first lubricant boiling range product has a kinematic viscosity at 100° C. of 4 to 10 cSt and the second lubricant boiling range product has a kinematic viscosity at 100° C. of 10 to 16 cSt, or c) both the first and second lubricant boiling range products have a kinematic viscosity at 100° C. of 4 to 10 cSt, and wherein the first lubricant boiling range product has a kinematic viscosity at 100° C. that is less than the kinematic viscosity at 100° C. of the second lubricant boiling range product.

Embodiment 14. The plurality of lubricant boiling range products formed according to the method of any of Embodiments 1-10 or formed using the system of claim 11.

Although the present disclosure has been described in terms of specific embodiments, it is not so limited. Suitable alterations/modifications for operation under specific conditions should be apparent to those skilled in the art. It is therefore intended that the following claims be interpreted as covering all such alterations/modifications as fall within the true spirit/scope of the disclosure.

1. A method for the fractionation of a lubricant boiling range feed, comprising:
introducing a lubricant boiling range feed into a flash zone of a distillation tower, the distillation tower having a pressure of 3.5 kPa-a or less and a water vapor partial pressure of 0.5 kPa-a or less; and
separating the lubricant boiling range feed into at least a first lubricant boiling range product and a second lubricant boiling range product, wherein the first lubricant boiling range product has a T95 boiling point that is greater than a T5 boiling point of the second lubricant boiling range product by 14° C. or less, and wherein a T95 boiling point of the second lubricant boiling range product is greater than the T95 boiling point of the first lubricant boiling range product.

2. The method of claim 1, wherein the T95 boiling point of the first lubricant boiling range product is greater than the T5 boiling point of the second lubricant boiling range product by 11° C. or less.

3. The method of claim 1, further comprising withdrawing a fraction of the lubricant boiling range feed from the distillation tower and passing a portion of the fraction through a reboiler loop.

4. The method of claim 1, further comprising withdrawing a fraction of the lubricant boiling range feed from the distillation tower and passing a portion of the fraction through a stripper, wherein a stripper medium in the stripper comprises a heated vapor stream from a reboiler loop associated with the stripper, and wherein the heated vapor stream comprises a stream of vaporized components of the fraction formed in the reboiler loop.

5. The method of claim 1, wherein the water vapor partial pressure corresponds to a water vapor partial pressure based on introducing substantially no additional water into the distillation tower.

6. The method of claim 1, wherein the plurality of lubricant boiling range products further comprises a liquid bottoms fraction, wherein the liquid bottoms fraction has a temperature of 650° F. (343° C.) or less as the liquid bottoms fraction exits the distillation tower.

7. The method of claim 1, wherein the first lubricant boiling range product has a kinematic viscosity at 100° C. of 2 to 4 cSt and the second lubricant boiling range product has a kinematic viscosity at 100° C. of 4 to 10 cSt.

8. The method of claim 1, wherein the first lubricant boiling range product has a kinematic viscosity at 100° C. of 4 to 10 cSt and the second lubricant boiling range product has a kinematic viscosity at 100° C. of 10 to 16 cSt.

9. The method of claim 1, wherein both the first and second lubricant boiling range products have a kinematic viscosity at 100° C. of 4 to 10 cSt, and wherein the first lubricant boiling range product has a kinematic viscosity at 100° C. that is less than the kinematic viscosity at 100° C. of the second lubricant boiling range product.

10. The method of claim 1, wherein separating the lubricant boiling range feed further comprises forming at least one diesel boiling range fraction, at least one naphtha boiling range fraction, or a combination thereof.

11. The method of claim 1, wherein an overhead fraction from the distillation tower comprises naphtha boiling range compounds or light ends.

12. The method of claim 1, wherein the distillation tower has a pressure of 2.0 kPa-a or less.

13. The method of claim 1, further comprising heating the lubricant boiling range feed to a temperature of 752° F. (400° C.) or less prior to introducing the lubricant boiling range feed into the flash zone.

14. The method of claim 1, wherein the lubricant boiling range feed has a T20 boiling point of at least 343° C.

15. A system for the fractionation of a lubricant boiling range feed, comprising a distillation tower having a pressure of 3.5 kPa-a or less and a water vapor partial pressure of 0.5 kPa-a or less, the distillation tower having a lubricant boiling range feed therein, the lubricant boiling range feed having a viscosity index (VI) of at least 50;
at least one stripper in fluid communication with the distillation tower; and
at least one reboiler loop in fluid communication with the stripper, wherein the distillation tower comprises a plurality of fractionation outlets for removing fractions from the distillation tower.

16. The system of claim 15, wherein the stripper includes a liquid fraction withdrawn from the distillation tower and a stripper medium comprising a vaporized portion of the fraction heated in the reboiler loop.

17. A plurality of lubricant boiling range products, comprising:
first and second lubricant boiling range products formed by the fractionation of a hydroprocessed and/or solvent processed lubricant boiling range feed in a distillation tower,
wherein the first lubricant boiling range product has a T95 boiling point that is greater than a T5 boiling point of the second lubricant boiling range product by 14° C. or less, and wherein a T95 boiling point of the second lubricant boiling range product is greater than the T95 boiling point of the first lubricant boiling range product.

18. The plurality of lubricant boiling range products of claim 17, wherein the first lubricant boiling range product has a kinematic viscosity at 100° C. of 2 to 4 cSt and the second lubricant boiling range product has a kinematic viscosity at 100° C. of 4 to 10 cSt.

19. The plurality of lubricant boiling range products of claim 17, wherein the first lubricant boiling range product has a kinematic viscosity at 100° C. of 4 to 10 cSt and the second lubricant boiling range product has a kinematic viscosity at 100° C. of 10 to 16 cSt.

20. The plurality of lubricant boiling range products of claim 17, wherein both the first and second lubricant boiling range products have a kinematic viscosity at 100° C. of 4 to 10 cSt, and wherein the first lubricant boiling range product has a kinematic viscosity at 100° C. that is less than the kinematic viscosity at 100° C. of the second lubricant boiling range product.
